(19) United States
(12) Patent Application Publication
(10) Pub. No.: US 2015/0071193 A1
(43) Pub. Date: Mar. 12, 2015

(54) SIGNAL TRANSMISSION METHOD AND USER EQUIPMENT, AND SIGNAL RECEPTION METHOD AND BASE STATION

(71) Applicant: LG ELECTRONICS INC., Seoul (KR)

(72) Inventor: Hanbyul Seo, Anyang-si (KR)

(21) Appl. No.: 14/382,653

(22) PCT Filed: Mar. 5, 2013
(86) PCT No.: PCT/KR2013/001767

§ 371 Date: Sep. 3, 2014

Related U.S. Application Data
(60) Provisional application No. 61/608,083, filed on Mar. 7, 2012.

(51) Int. Cl. H04L 5/00; H04L 1/18

(52) U.S. Cl. CPC H04L 5/0055; H04L 1/1854; H04L 5/0062
USPC 370/329

(57) ABSTRACT

According to the present invention, user equipment performs an HARQ operation for a signal in consideration of the interference experienced by the signal when the signal is received by the user equipment. An apparatus transmitting a signal to the user equipment retransmits the signal in consideration of the interference experienced by the signal when the signal reaches the user equipment on the basis of ACK/NACK information from the user equipment.

### TECHNICAL FIELD

The present invention relates to a wireless communication system and, more particularly, to a method and apparatus for transmitting signals and a method and apparatus for receiving signals.

### BACKGROUND ART

With appearance and spread of machine-to-machine (M2M) communication and a variety of devices such as smartphones and tablet PCs and technology demanding a large amount of data transmission, data throughput needed in a cellular network has rapidly increased. To satisfy such rapidly increasing data throughput, carrier aggregation technology, cognitive radio technology, etc. for efficiently employing more frequency bands and multiple input multiple output (MIMO) technology, multi-base station (BS) cooperation technology, etc. for raising data capacity transmitted on limited frequency resources have been developed. In addition, a communication environment has evolved into increasing density of nodes accessible by a user at the periphery of the nodes. A node refers to a fixed point capable of transmitting/receiving a radio signal to/from a user equipment through one or more antennas. A communication system including high-density nodes may provide a better communication service to the user through cooperation between the nodes.

For these reasons, the probability of generating collision between signals transmitted by a plurality of transmitting devices is gradually increasing. Accordingly, mutual interference between the signals transmitted by the transmitting devices becomes severer. Collision or interference between the transmitted signals leads to degradation of a signal colliding with other signals or a signal subject to interference from other signals, so that the degraded signal may have a risk of being judged by a receiving device as a different signal different from an original signal that a transmitting device desires to transmit.

### DETAILED DESCRIPTION OF THE INVENTION

### Technical Problems

Therefore, an error control method considering that strong interference may be present between transmission signals is needed.

In addition, a method for efficiently performing error control for transmission signals is needed.

The technical objects that can be achieved through the present invention are not limited to what has been particularly described hereinabove and other technical objects not described herein will be more clearly understood by persons skilled in the art from the following detailed description.

### Technical Solutions

In an aspect of the present invention, provided herein is a method for receiving a signal by a user equipment, including decoding a data signal based on a scheduling message for the data signal; and transmitting acknowledgement (ACK)/negative acknowledgement (NACK) feedback including an ACK/NACK response to the data signal. If the data signal is successfully decoded, the ACK/NACK response may be set to a first value indicating successful reception. If the data signal is unsuccessfully decoded and reception quality of the data signal is greater than a reference value, the ACK/NACK response may be set to a second value indicating unsuccessful reception. If the data signal is unsuccessfully decoded and reception quality of the data signal is less than the reference value, the ACK/NACK response may be set to a third value indicating detection failure of the data signal or the ACK/NACK response may dropped.

In another aspect of the present invention, provided herein is a user equipment for receiving a signal, including a radio frequency (RF) unit and a processor configured to control the RF unit, wherein the processor controls the RF unit to receive a scheduling message for a data signal, decodes the data signal based on the scheduling message, and controls the RF unit to transmit acknowledgement (ACK)/negative acknowledgement (NACK) feedback including an ACK/NACK response to the data signal. If the data signal is successfully decoded, the processor may set the ACK/NACK response to a first value indicating successful reception, and if the data signal is unsuccessfully decoded and reception quality of the data signal is greater than a reference value, the processor may set the ACK/NACK response to a second value indicating unsuccessful reception. If the data signal is unsuccessfully decoded and reception quality of the data signal is less than the reference value, the processor may set the ACK/NACK response to a third value indicating detection failure of the data signal or drop the ACK/NACK response.

In another aspect of the present invention, provided herein is a method for transmitting a signal by a transmitting device, including transmitting a data signal based on a scheduling message for the data signal to a user equipment; and receiving acknowledgement (ACK)/negative acknowledgement (NACK) feedback from the user equipment. If an ACK/NACK response of the ACK/NACK feedback to the data signal is set to a first value, the transmitting device may assume that the data signal has been successfully received by the user equipment and, if the ACK/NACK response of the ACK/NACK feedback is set to a second value, the transmitting device may assume that the data signal has been unsuccessfully received by the user equipment. If the ACK/NACK response of the ACK/NACK feedback indicates detection failure of the data signal or if the ACK/NACK feedback does not include the ACK/NACK response, the transmitting device may assume that the data signal has been received by the user equipment with quality less than a reference value.

In another aspect of the present invention, provided herein is a transmitting device for transmitting a signal, including a radio frequency (RF) unit and a processor configured to control the RF unit, wherein the processor controls the RF unit to transmit a data signal based on a scheduling message for the data signal to a user equipment and controls the RF unit to receive acknowledgement (ACK)/negative acknowledgement (NACK) feedback including an ACK/NACK response to the data signal from the user equipment. If the ACK/NACK response of the ACK/NACK feedback to the data signal is set to a first value, the processor may assume that the data signal has been successfully received by the user equipment and, if the ACK/NACK response of the ACK/NACK feedback is set to a second value, the processor may assume that the data signal has been unsuccessfully received by the user equipment. If the ACK/NACK response of the ACK/NACK feedback indicates detection failure of the data signal or if the ACK/NACK feedback does not include the ACK/NACK response, the processor may assume that the data signal has been received by the user equipment with quality less than a reference value.

In each aspect of the present invention, if the data signal is unsuccessfully decoded and reception quality of the data signal is less than the reference value, the data signal may be discarded from a hybrid automatic retransmission request (HARQ) buffer of the user equipment.

In each aspect of the present invention, the data signal may be decoded when the scheduling message is successfully decoded.

In each aspect of the present invention, if the data signal is unsuccessfully decoded and reception quality of the data signal is less than the reference value, another data signal having the same redundancy version as a redundancy version of the data signal may be transmitted again to the user equipment.

The above technical solutions are merely some parts of the embodiments of the present invention and various embodiments into which the technical features of the present invention are incorporated can be derived and understood by persons skilled in the art from the following detailed description of the present invention.

### Advantageous Effects

According to the present invention, a control message for retransmission can be prevented from being meaninglessly transmitted.

In addition, according to the present invention, retransmission by a transmitting device can be prevented from being meaninglessly performed and a receiving device can be prevented from unnecessarily performing an operation.

Further, according to the present invention, a hybrid automatic retransmission request (HARQ) operation can be more efficiently performed.

Furthermore, according to the present invention, radio resources can be efficiently used.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention.

FIG. 1 illustrates the structure of a radio frame used in a wireless communication system.

FIG. 2 illustrates the structure of a downlink (DL)/uplink (UL) slot in a wireless communication system.

FIG. 3 illustrates the structure of a DL subframe used in a wireless communication system.

FIG. 4 illustrates the structure of a UL subframe used in a wireless communication system.

FIG. 5 illustrates communication environments to which the present invention is applicable.

FIG. 6 illustrates a flow of a HARQ operation according to the present invention.

FIG. 7 illustrates an exemplary HARQ-ACK feedback method according to the present invention.

FIG. 8 is a block diagram illustrating elements of a transmitting device 10 and a receiving device 20 for implementing the present invention.

### MODE FOR INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802-20, or evolved UTRA (E-UTRA). UTRA is a part of a universal mobile telecommunications system (UMTS). 3rd generation partnership project (3GPP) long term evolution (LTE) is a part of evolved. UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP LTE/LTE-A. However, the technical features of the present invention are not limited thereto. For example, although the following detailed description is given based on a mobile communication system corresponding to a 3GPP LTE/LTE-A system, aspects of the present invention that are not specific to 3GPP LTE/LTE-A are applicable to other mobile communication systems.

In some instances, known structures and devices are omitted or are shown in block diagram form, focusing on important features of the structures and devices, so as not to obscure the concept of the present invention. The same reference numbers will be used throughout this specification to refer to the same or like parts.

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. In describing the present invention, a BS will be referred to as an eNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, a node may not be an eNB. For example, a radio remote head (RRH) or a radio remote unit (RRU) may be a node. The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio link. At least one antenna is installed per node. The antenna may mean a physical antenna, an antenna port, a virtual antenna, or an antenna group. A node may be referred to as a point.

In the present invention, a cell refers to a prescribed geographical area to which one or more nodes provide a communication service. Accordingly, in the present invention, communicating with a specific cell may mean communicating with an eNB or a node which provides a communication service to the specific cell. In addition, a downlink/uplink signal of a specific cell refers to a downlink/uplink signal from/to an eNB or a node which provides a communication service to the specific cell. Furthermore, channel status/quality of a specific cell refers to channel status/quality of a channel or communication link formed between an eNB or node which provides a communication service to the specific cell and a UE. In a 3GPP LTE/LTE-A based system, the UE may measure a downlink channel state from a specific node using channel state information-reference signal(s) (CSI-RS(s)) transmitted on a CSI-RS resource allocated to the specific node by antenna port(s) of the specific node. Meanwhile, a 3GPP LTE/LTE-A system uses the concept of a cell in order to manage radio resources and a cell associated with the radio resources is distinguished from a cell of a geographic region.

3GPP LTE/LTE-A standards define DL physical channels corresponding to resource elements carrying information derived from a higher layer and DL physical signals corresponding to resource elements which are used by a physical layer but which do not carry information derived from a higher layer. For example, a physical downlink shared channel (PDSCH), a physical broadcast channel (PBCH), a physical multicast channel (PMCH), a physical control format indicator channel (PCFICH), a physical downlink control channel (PDCCH), and a physical hybrid ARQ indicator channel (PHICH) are defined as the DL physical channels, and a reference signal and a synchronization signal are defined as the DL physical signals. A reference signal (RS), also called a pilot, refers to a special waveform of a predefined signal known to both a BS and a UE. For example, a cell-specific RS (CRS), a UE-specific RS, a positioning RS (PRS), and channel state information RS (CSI-RS) may be defined as DL RSs. Meanwhile, the 3GPP LTE/LTE-A standards define UL physical channels corresponding to resource elements carrying information derived from a higher layer and UL physical signals corresponding to resource elements which are used by a physical layer but which do not carry information derived from a higher layer. For example, a physical uplink shared channel (PUSCH), a physical uplink control channel (PUCCH), and a physical random access channel (PRACH) are defined as the UL physical channels, and a demodulation reference signal (DM RS) for a UL control/data signal and a sounding reference signal (SRS) used for UL channel measurement are defined as the UL physical signals.

In the present invention, a physical downlink control channel (PDCCH), a physical control format indicator channel (PCFICH), a physical hybrid automatic retransmit request indicator channel (PHICH), and a physical downlink shared channel (PDSCH) refer to a set of time-frequency resources or resource elements (REs) carrying downlink control information (DCI), a set of time-frequency resources or REs carrying a control format indicator (CFI), a set of time-frequency resources or REs carrying downlink acknowledgement (ACK)/negative ACK (NACK), and a set of time-frequency resources or REs carrying downlink data, respectively. In addition, a physical uplink control channel (PUCCH), a physical uplink shared channel (PUSCH) and a physical random access channel (PRACH) refer to a set of time-frequency resources or REs carrying uplink control information (UCI), a set of time-frequency resources or REs carrying uplink data and a set of time-frequency resources or REs carrying random access signals, respectively. In the present invention, in particular, a time-frequency resource or RE that is assigned to or belongs to PDCCH/PCFICH/PHICH/PDSCH/PUCCH/PUSCH/PRACH is referred to as PDCCH/PCFICH/PHICH/PDSCH/PUCCH/PUSCH/PRACH RE or PDCCH/PCFICH/PHICH/PDSCH/PUCCH/PUSCH/PRACH time-frequency resource, respectively. Therefore, in the present invention, PUCCH/PUSCH/PRACH transmission of a UE is conceptually identical to UCI/uplink data/random access signal transmission on PUSCH/PUCCH/PRACH, respectively. In addition, PDCCH/PCFICH/PHICH/PDSCH transmission of an eNB is conceptually identical to downlink data/DCI transmission on PDCCH/PCFICH/PHICH/PDSCH, respectively.

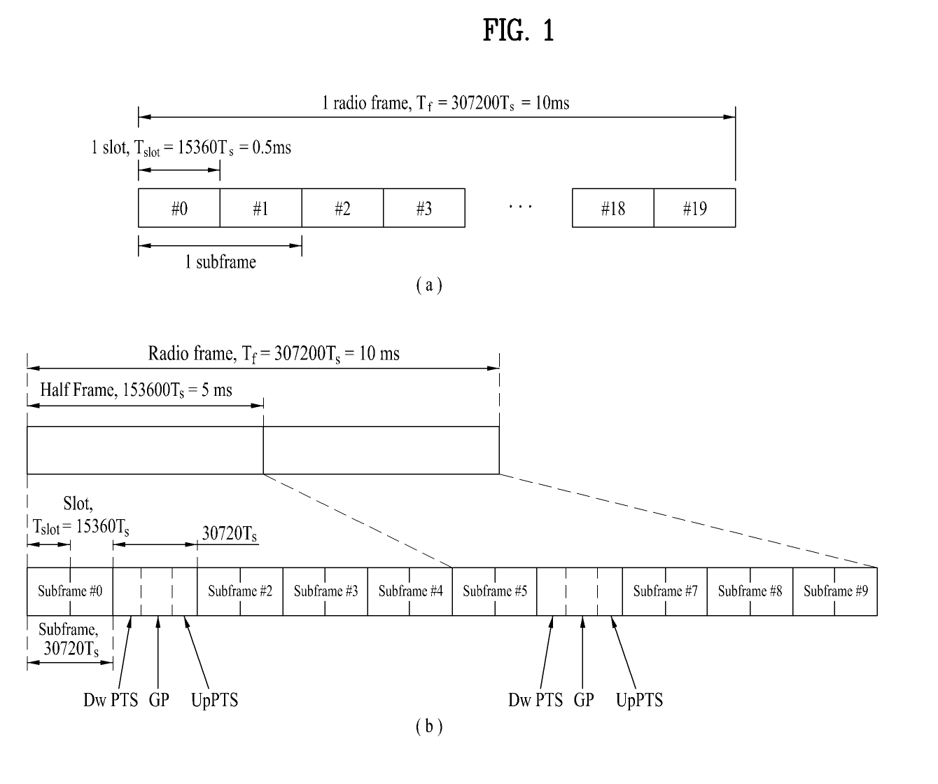

FIG. 1 illustrates the structure of a radio frame used in a wireless communication system.

Specifically, FIG. 1(a) illustrates an exemplary structure of a radio frame which can be used in frequency division multiplexing (FDD) in 3GPP LTE/LTE-A and FIG. 12(b) illustrates an exemplary structure of a radio frame which can be used in time division multiplexing (TDD) in 3GPP LTE/LTE-A.

Referring to FIG. 1, a 3GPP LTE/LTE-A radio frame is 10 ms (307,200Tₛ) in duration. The radio frame is divided into 10 subframes of equal size. Subframe numbers may be assigned to the 10 subframes within one radio frame, respectively. Here, Tₛ denotes sampling time where Tₛ=1/(2048*15 kHz). Each subframe is 1 ms long and further divided into two slots. 20 slots are sequentially numbered from 0 to 19 in one radio frame. Duration of each slot is 0.5 ms. A time interval in which one subframe is transmitted is defined as a transmission time interval (TTI). Time resources may be distinguished by a radio frame number (or radio frame index), a subframe number (or subframe index), a slot number (or slot index), and the like.

A radio frame may have different configurations according to duplex modes. In FDD mode for example, since downlink (DL) transmission and uplink (UL) transmission are discriminated according to frequency, a radio frame for a specific frequency band operating on a carrier frequency includes either DL subframes or UL subframes. In TDD mode, since DL transmission and UL transmission are discriminated according to time, a radio frame for a specific frequency band operating on a carrier frequency includes both DL subframes and UL subframes.

Table 1 shows an exemplary UL-DL configuration within a radio frame in TDD mode.

TABLE 1

| DL-UL | Downlink-to-Uplink switch- | Subframe number | | | | | | | | | |
|---|---|---|---|---|---|---|---|---|---|---|---|
| configuration | point periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a DL subframe, U denotes a UL subframe, and S denotes a special subframe. The special subframe includes three fields, i.e. downlink pilot time slot (DwPTS), guard period (GP), and uplink pilot time slot (UpPTS). DwPTS is a time slot reserved for DL transmission and UpPTS is a time slot reserved for UL transmission. Table 2 shows an example of the special subframe configuration.

TABLE 2

| | | | | Extended cyclic prefix in downlink | | |
|---|---|---|---|---|---|---|
| | Normal cyclic prefix in downlink | | | | UpPTS | |
| | | UpPTS | | | | Extended |
| Special | | Normal | Extended | | Normal | cyclic |
| subframe | | cyclic prefix | cyclic prefix | | cyclic prefix | prefix in |
| configuration | DwPTS | in uplink | in uplink | DwPTS | in uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

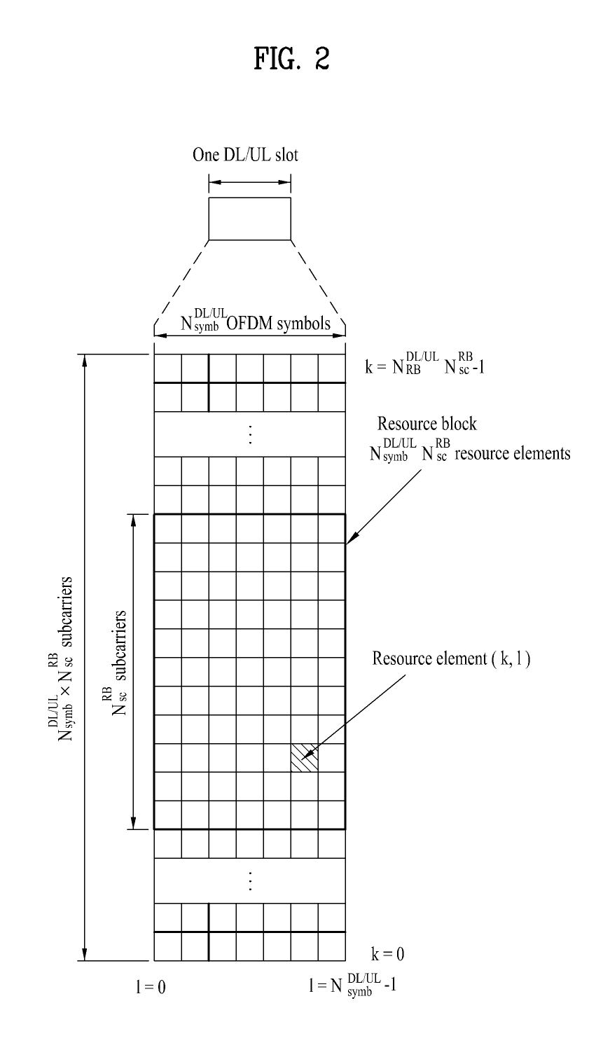

FIG. 2 illustrates the structure of a DL/UL slot structure in a wireless communication system. In particular, FIG. 2 illustrates the structure of a resource grid of a 3GPP LTE/LTE-A system. One resource grid is defined per antenna port.

Referring to FIG. 2, a slot includes a plurality of orthogonal frequency division multiplexing (OFDM) symbols in the time domain and includes a plurality of resource blocks (RBs) in the frequency domain. The OFDM symbol may refer to one symbol duration. Referring to FIG. 2, a signal transmitted in each slot may be expressed by a resource grid including N^{DL/UL}_{RB}*N^{RB}_{sc} subcarriers and N^{DL/UL}_{symb} OFDM symbols. N^{DL}_{RB} denotes the number of RBs in a DL slot and N^{UL}_{RB} denotes the number of RBs in a UL slot. N^{DL}_{RB} and N^{UL}_{RB} depend on a DL transmission bandwidth and a UL transmission bandwidth, respectively. N^{DL}_{symb} denotes the number of OFDM symbols in a DL slot, N^{UL}_{symb} denotes the number of OFDM symbols in a UL slot, and N^{RB}_{sc} denotes the number of subcarriers configuring one RB.

An OFDM symbol may be referred to as an OFDM symbol, an SC-FDM symbol, etc. according to multiple access schemes. The number of OFDM symbols included in one slot may be varied according to channel bandwidths and CP lengths. For example, in a normal cyclic prefix (CP) case, one slot includes 7 OFDM symbols. In an extended CP case, one slot includes 6 OFDM symbols. Although one slot of a subframe including 7 OFDM symbols is shown in FIG. 2 for convenience of description, embodiments of the present invention are similarly applicable to subframes having a different number of OFDM symbols. Referring to FIG. 2, each OFDM symbol includes N^{DL/UL}_{RB}*N^{RB}_{sc} subcarriers in the frequency domain. The type of the subcarrier may be divided into a data subcarrier for data transmission, a reference signal (RS) subcarrier for RS transmission, and a null subcarrier for a guard band and a DC component. The null subcarrier for the DC component is unused and is mapped to a carrier frequency f₀ in a process of generating an OFDM signal or in a frequency up-conversion process. The carrier frequency is also called a center frequency f_{c}.

One RB is defined as N^{DL/UL}_{symb} (e.g. 7) consecutive OFDM symbols in the time domain and as N^{RB}_{sc} (e.g. 12) consecutive subcarriers in the frequency domain. For reference, a resource composed of one OFDM symbol and one subcarrier is referred to a resource element (RE) or tone. Accordingly, one RB includes N^{DU/UL}_{symb}*N^{RB}_{sc} REs. Each RE within a resource grid may be uniquely defined by an index pair (k, l) within one slot. k is an index ranging from 0 to N^{DL/UL}_{RB}*N^{RB}_{sc}−1 in the frequency domain, and l is an index ranging from 0 to N^{DU/UL}_{symb}1−1 in the time domain.

Meanwhile, one RB is mapped to one physical resource block (PRB) and one virtual resource block (VRB). A PRB is defined as N^{DL}_{symb} (e.g. 7) consecutive OFDM symbols in the time domain and N^{RB}_{sc} (e.g. 12) consecutive subcarriers in the frequency domain. Accordingly, one PRB is configured with N^{DU/UL}_{symb}*N^{RB}_{sc} REs. In one subframe, two RBs each located in two slots of the subframe while occupying the same N^{RB}_{sc} consecutive subcarriers are referred to as a physical resource block (PRB) pair. Two RBs configuring a PRB pair have the same PRB number (or the same PRB index).

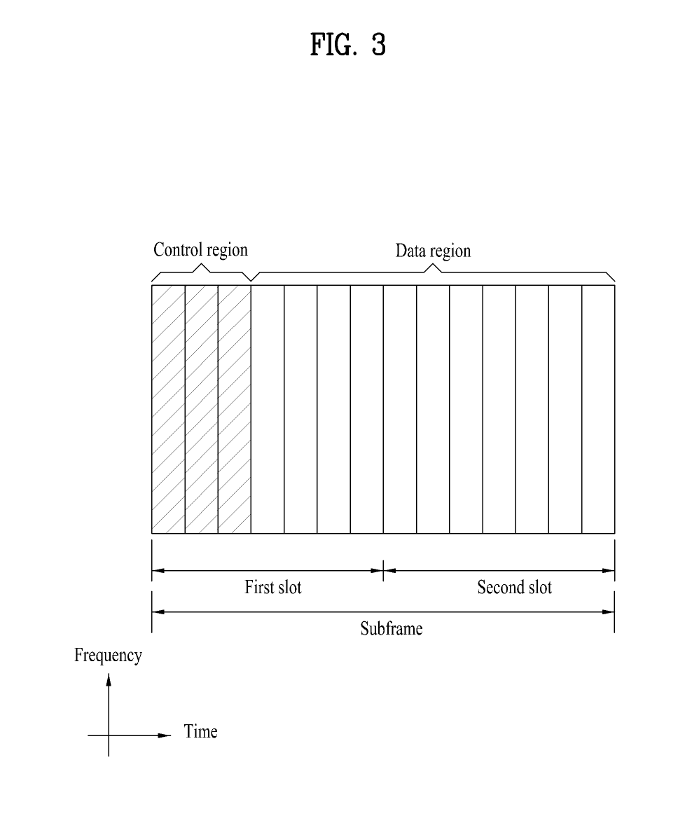

FIG. 3 illustrates the structure of a DL subframe used in a wireless communication system.

Referring to FIG. 3, a DL subframe is divided into a control region and a data region in the time domain. Referring to FIG. 3, a maximum of 3 (or 4) OFDM symbols located in a front part of a first slot of a subframe corresponds to the control region. Hereinafter, a resource region for PDCCH transmission in a DL subframe is referred to as a PDCCH region. OFDM symbols other than the OFDM symbol(s) used in the control region correspond to the data region to which a physical downlink shared channel (PDSCH) is allocated. Hereinafter, a resource region available for PDSCH transmission in the DL subframe is referred to as a PDSCH region. Examples of a DL control channel used in 3GPP LTE include a physical control format indicator channel (PCFICH), a physical downlink control channel (PDCCH), a physical hybrid ARQ indicator channel (PHICH), etc. The PCFICH is transmitted in the first OFDM symbol of a subframe and carries information about the number of OFDM symbols available for transmission of a control channel within a subframe. The PHICH carries a HARQ (Hybrid Automatic Repeat Request) ACK/NACK (acknowledgment/negative-acknowledgment) signal as a response to UL transmission.

The control information transmitted through the PDCCH will be referred to as downlink control information (DCI). The DCI includes resource allocation information for a UE or UE group and other control information. A transmit format and resource allocation information of a downlink shared channel (DL-SCH) are referred to as DL scheduling information or DL grant and a transmit format and resource allocation information of an uplink shared channel (UL-SCH) are referred to as UL scheduling information or UL grant. DCI carried by one PDCCH may differ in size and use according to DCI format and differ in size according to coding rate.

A plurality of PDCCHs may be transmitted within a control region. A UE may monitor the plurality of PDCCHs. An eNB determines a DCI format depending on the DCI to be transmitted to the UE, and attaches cyclic redundancy check (CRC) to the DCI. The CRC is masked (or scrambled) with an identifier (for example, radio network temporary identifier (RNTI)) depending on usage of the PDCCH or owner of the PDCCH. For example, if the PDCCH is for a specific UE, the CRC may be masked with an identifier (for example, cell-RNTI (C-RNTI)) of the corresponding UE. If the PDCCH is for a paging message, the CRC may be masked with a paging identifier (for example, Paging-RNTI (P-RNTI)). If the PDCCH is for system information (in more detail, system information block (SIB)), the CRC may be masked with system information RNTI (SI-RNTI). If the PDCCH is for a random access response, the CRC may be masked with a random access RNTI (RA-RNTI). For example, CRC masking (or scrambling) includes XOR operation of CRC and RNTI at a bit level.

The PDCCH is transmitted on an aggregation of one or a plurality of continuous control channel elements (CCEs). The CCE is a logic allocation unit used to provide a coding rate based on the status of a radio channel to the PDCCH. The CCE corresponds to a plurality of resource element groups (REGs). For example, one CCE corresponds to nine resource element groups (REGs), and one REG corresponds to four REs. Four QPSK symbols are mapped into each REG. A resource element (RE) occupied by the reference signal (RS) is not included in the REG. Accordingly, the number of REGs within given OFDM symbols is varied depending on the presence of the RS. The REGs are also used for other downlink control channels (that is, PDFICH and PHICH). The number of DCI formats and DCI bits is determined in accordance with the number of CCEs. CCEs are numbered and used consecutively. In order to simplify a decoding process, the PDCCH having a format that includes n CCEs may only start on a CCE having a CCE number corresponding to a multiple of n. The number of CCEs used for transmission of a specific PDCCH is determined by the eNB in accordance with channel status. For example, one CCE may be required for a PDCCH for a UE (for example, adjacent to eNB) having a good downlink channel. However, in case of a PDCCH for a UE (for example, located near the cell edge) having a poor channel, eight CCEs may be required to obtain sufficient robustness. Additionally, a power level of the PDCCH may be adjusted to correspond to a channel status.

In a 3GPP LTE/LTE-A system, a CCE set in which a PDCCH can be located for each UE is defined. A CCE set in which the UE can detect a PDCCH thereof is referred to as a PDCCH search space or simply as a search space (SS). An individual resource on which the PDCCH can be transmitted in the SS is called a PDCCH candidate. A set of PDCCH candidates that the UE is to monitor is defined as the SS. SSs may have different sizes and a dedicated SS and a common SS are defined. The dedicated SS is a UE-specific SS and is configured for each individual UE. The common SS is configured for a plurality of UEs. All UEs receive information about the common SS. An eNB transmits an actual PDCCH (DCI) on a PDCCH candidate in a search space and a UE monitors the search space to detect the PDCCH (DCI). Here, monitoring implies attempting to decode each PDCCH in the corresponding SS according to all monitored DCI formats. The UE may detect a PDCCH thereof by monitoring a plurality of PDCCHs. Basically, the UE does not know the location at which a PDCCH thereof is transmitted. Therefore, the UE attempts to decode all PDCCHs of the corresponding DCI format for each subframe until a PDCCH having an ID thereof is detected and this process is referred to as blind detection (or blind decoding (BD)).

For example, it is assumed that a specific PDCCH is CRC-masked with a radio network temporary identity (RNTI) ‘A’ and information about data transmitted using a radio resource ‘B’ (e.g. frequency location) and using transport format information ‘C’ (e.g. transmission block size, modulation scheme, coding information, etc.) is transmitted in a specific DL subframe. Then, the UE monitors the PDCCH using RNTI information thereof. The UE having the RNTI ‘A’ receives the PDCCH and receives the PDSCH indicated by ‘B’ and ‘C’ through information of the received PDCCH.

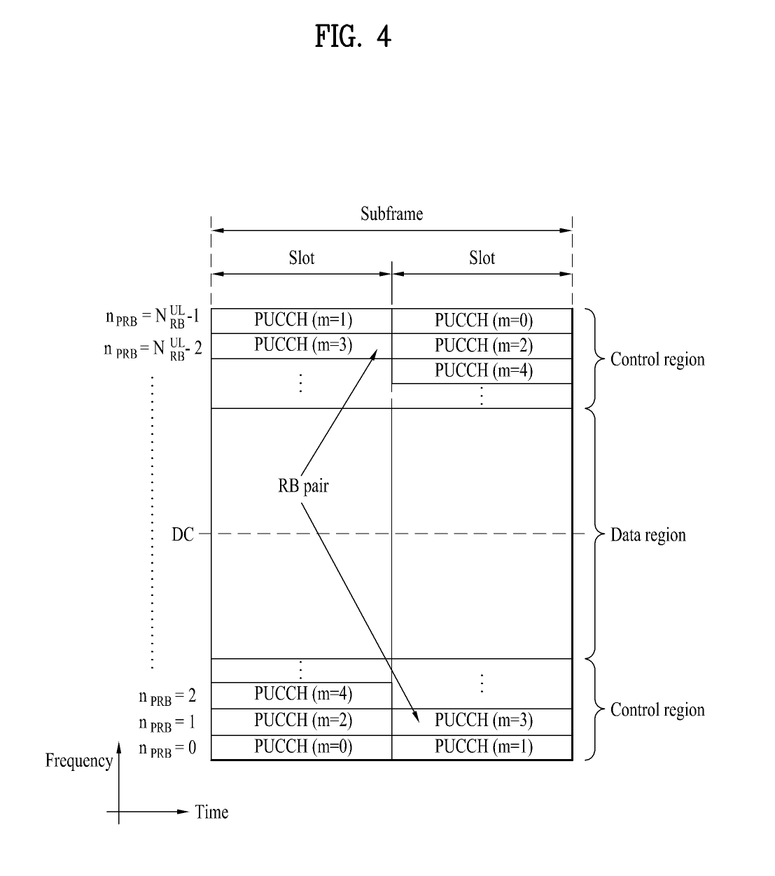

FIG. 4 illustrates the structure of a UL subframe used in a wireless communication system.

Referring to FIG. 4, a UL subframe may be divided into a data region and a control region in the frequency domain. One or several PUCCHs may be allocated to the control region to deliver UCI. One or several PUSCHs may be allocated to the data region of the UE subframe to carry user data.

In the UL subframe, subcarriers distant from a direct current (DC) subcarrier are used as the control region. In other words, subcarriers located at both ends of a UL transmission BW are allocated to transmit UCI. A DC subcarrier is a component unused for signal transmission and is mapped to a carrier frequency f₀ in a frequency up-conversion process. A PUCCH for one UE is allocated to an RB pair belonging to resources operating on one carrier frequency and RBs belonging to the RB pair occupy different subcarriers in two slots. The PUCCH allocated in this way is expressed by frequency hopping of the RB pair allocated to the PUCCH over a slot boundary. If frequency hopping is not applied, the RB pair occupies the same subcarriers.

The PUCCH may be used to transmit the following control information.
Scheduling request (SR): SR is information used to request a UL-SCH resource and is transmitted using an on-off keying (OOK) scheme.
HARQ-ACK: HARQ-ACK is a response to a PDCCH and/or a response to a DL data packet (e.g. a codeword) on a PDSCH. HARQ-ACK indicates whether the PDCCH or PDSCH has been successfully received. 1-bit HARQ-ACK is transmitted in response to a single DL codeword and 2-bit HARQ-ACK is transmitted in response to two DL codewords. A HARQ-ACK response includes a positive ACK (simply, ACK), negative ACK (NACK), discontinuous transmission (DTX), or NACK/DRX. HARQ-ACK is used interchangeably with HARQ ACK/NACK and ACK/NACK.
Channel state information (CSI): CSI is feedback information for a DL channel. MIMO-related feedback information includes a rank indicator (RI) and a precoding matrix indicator (PMI).

HARQ is a method used for error control. HARQ-ACK transmitted in DL is used for error control regarding UL data and HARQ-ACK transmitted in UL is used for error control regarding DL data. In DL, an eNB schedules one or more RBs for a UE selected according to a predetermined scheduling rule and transmits data to the UE using the scheduled RBs. Hereinafter, scheduling information for DL transmission will be referred to as a DL grant and a PDCCH carrying the DL grant will be referred to as a DL grant PDCCH. In UL, the eNB schedules one or more RBs for a UE selected according to a predetermined scheduling rule and the UE transmits data using allocated resources in UL. A transmitting device performing a HARQ operation waits for an ACK signal after transmitting data (e.g. transport blocks or codewords). A receiving device performing the HARQ operation transmits an ACK signal only when the data has been correctly received and transmits a NACK signal when there is an error in the received data. Upon receiving the ACK signal, the transmitting device transmits next (new) data but, upon receiving the NACK signal, the transmitting device retransmits data. In a HARQ scheme, error data is stored in a HARQ buffer and initial data is combined with retransmission data in order to raise reception success rate.

The HARQ scheme is categorized as synchronous HARQ and asynchronous HARQ according to retransmission timing and as channel-adaptive HARQ and channel-non-adaptive HARQ depending upon whether channel state is considered during determination of the amount of retransmission resources.

In the synchronous HARQ scheme, when initial transmission fails, retransmission is performed at a timing determined by a system. For example, if it is assumed that retransmission is performed in every X-th (e.g. X=4) time unit (e.g. a TTI or subframe) after initial transmission fails, an eNB and a UE do not need to exchange information about retransmission timing. Therefore, upon receiving a NACK message, the transmitting device may retransmit corresponding data in every fourth time unit until an ACK message is received. In contrast, in the asynchronous HARQ scheme, retransmission timing is determined by new scheduling or additional signaling. That is, the retransmission timing for error data may be changed by various factors such as channel state.

In the channel-non-adaptive HARQ scheme, a modulation and coding scheme (MCS), the number of RBs, etc., which are needed for retransmission, are determined as those during initial transmission. In contrast, in the channel-adaptive HARQ scheme, the MCS, the number of RBs, etc. for retransmission are changed according to channel state. For example, in the channel-non-adaptive HARQ scheme, when initial transmission is performed using 6 RBs, retransmission is also performed using 6 RBs. In contrast, in the channel-adaptive HARQ scheme, even when initial transmission is performed using 6 RBs, retransmission may be performed using RBs less or greater in number than 6 according to channel state.

Based on such classification, a combination of the four HARQ schemes may be considered, but an asynchronous/channel-adaptive HARQ scheme and a synchronous/channel-non-adaptive HARQ scheme are mainly used. In the asynchronous/channel-adaptive HARQ scheme, the retransmission timing and the amount of retransmitted resources are adaptively changed according to channel state so as to maximize retransmission efficiency. However, since overhead is increased, this scheme is generally not considered in UL. Meanwhile, in the synchronous/channel-non-adaptive HAQR scheme, since the retransmission timing and retransmission resource allocation are determined by the system, almost no overhead occurs but retransmission efficiency is very low if this scheme is used in an environment in which the channel state is considerably changed. In current communication system, the asynchronous HARQ scheme is used in DL and the synchronous HARQ scheme is used in UL.

Meanwhile, a time delay occurs until an eNB receives ACK/NACK from a UE and transmits retransmission data after transmitting scheduling information and data according to the scheduling information. The time delay is generated due to a channel propagation delay or a time consumed for data decoding/encoding. Accordingly, if new data is transmitted after a HARQ process which is currently in progress is ended, a gap is created due to a time delay. In order to prevent a gap in data transmission from being created during a time delay duration, a plurality of independent HARQ processes is used. For example, when an interval between initial transmission and retransmission is 7 subframes, 7 independent HARQ processes may be performed to transmit data without a gap. A plurality of parallel HARQ processes enables successive UL/DL transmission while the eNB awaits HARQ feedback for previous UL/DL transmission. Each HARQ process is associated with a HARQ buffer of a medium access control (MAC) layer. Each HARQ process manages state parameters regarding the number of transmissions of a protocol data unit (PDU) in the buffer, HARQ feedback for a MAC PDU in the buffer, a current redundancy version, etc.

The present invention proposes a method for feeding back a result of a HARQ operation to an eNB or a transmitting device and performing an operation according to feedback, when the UE performs a HARQ operation. Upon receiving a data signal using a specific time/frequency resource, the UE checks whether the data signal has been correctly received. If the data signal has been correctly received, the UE transmits ACK and, if not, the UE feeds back NACK. For example, the UE may check whether the data signal has been correctly received by decoding the received data signal and performing CRC check for the decoded signal. If it is determined that decoding of the data signal is successful as a result of CRC check, ACK may be fed back and, if it is determined that decoding of the data signal is unsuccessful (i.e. failure), NACK may be fed back, as HARQ-ACK for the data signal. If ACK is reported, the eNB or the transmitting device determines that the data signal has been successfully received by the UE and, if another data signal is present for the UE, the eNB may transmit scheduling information for the other data signal and transmit the other data signal according to the scheduling information. In contrast, if NACK is reported, the eNB or the transmitting device transmits a signal capable of being used to restore corresponding data (hereinafter, restoration signal), so as to cause the UE to restore error data into original data. For example, the transmitting device transmits parity bit(s) for a data signal reported as having an error to the UE which has reported NACK, as the restoration signal. Upon failing to restore the data signal, the UE stores a reception signal in a HARQ buffer and, upon receiving the restoration signal later, the UE may combine the reception signal with the restoration signal. Hereinafter, the restoration signal will be referred to as a retransmission signal or retransmission data and a first transmitted original signal other than a signal transmitted as the restoration signal by the transmitting device will be referred to as an initial signal or initial data.

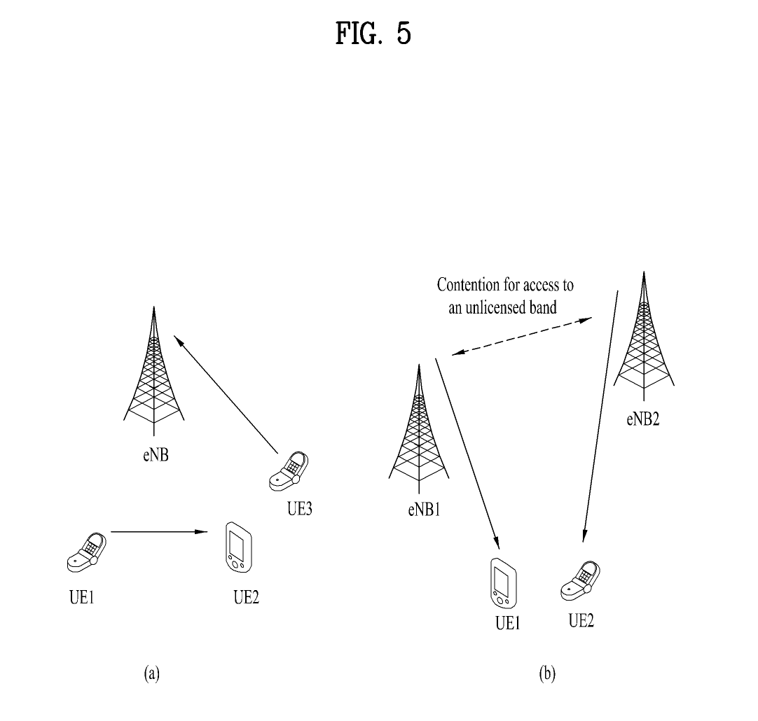

FIG. 5 illustrates communication environments to which the present invention is applicable.

In a specific communication environment, a data signal received at a specific time by a UE may be subject to severe interference by another signal. Referring to FIG. 5(a), for example, when UEs UE1 and UE2 perform direct data transmission and/or reception, if UE3 adjacent to UE2, which is a reception UE, transmits a signal of strong strength to an eNB which is separated therefrom by a considerable distance, a signal received by UE2 from UE1 may be subject to severe interference by the signal transmitted by UE3 to the eNB. As another example, referring to FIG. 5(b), UE1 may receive a signal of eNB1 through an unlicensed band. The unlicensed band is a frequency band that a specific operator is not assigned exclusive authority to use. Anyone who follows predetermined communication rules can use the unlicensed band. In contrast, a licensed band is a band that a specific operator has exclusive authority to use from a frequency allocation institution (e.g. government). To use the unlicensed band, a device (e.g. eNB1 of FIG. 5(b)) performs contention with another device (e.g. eNB2 of FIG. 5(b)) using the unlicensed band. As a result of channel occupation contention, transmission contention in which a plurality of devices simultaneously transmits signals may occur and a reception signal of a UE may be subject to severe interference by other signals due to mutual collision between simultaneously transmitted signals in the same band.

As described above, if a reception signal of a UE is subject to severe interference by a transmission signal of a neighboring device or a reception signal of a neighboring device, an original signal component of the reception signal of the UE has less power, whereas an interference signal component occupies large power. Consequently, combination of the reception signal of the UE with a signal retransmitted by a transmitting device, for a HARQ operation, hinders the UE from decoding an error correction code. Accordingly, the present invention proposes discarding a signal undergoing severe interference without being stored in a HARQ buffer of the UE. The present invention also proposes that a device transmitting a signal to the UE perform transmission as if the signal had never been previously transmitted during retransmission of the signal. For example, if a signal transmitted by a transmitting device to the UE (hereinafter, initial signal) reaches the UE after undergoing severe interference, the transmitting device may transmit the same signal as the initial signal rather than transmitting a restoration signal for restoring the initial signal. Embodiments of the present invention will be described below in more detail.

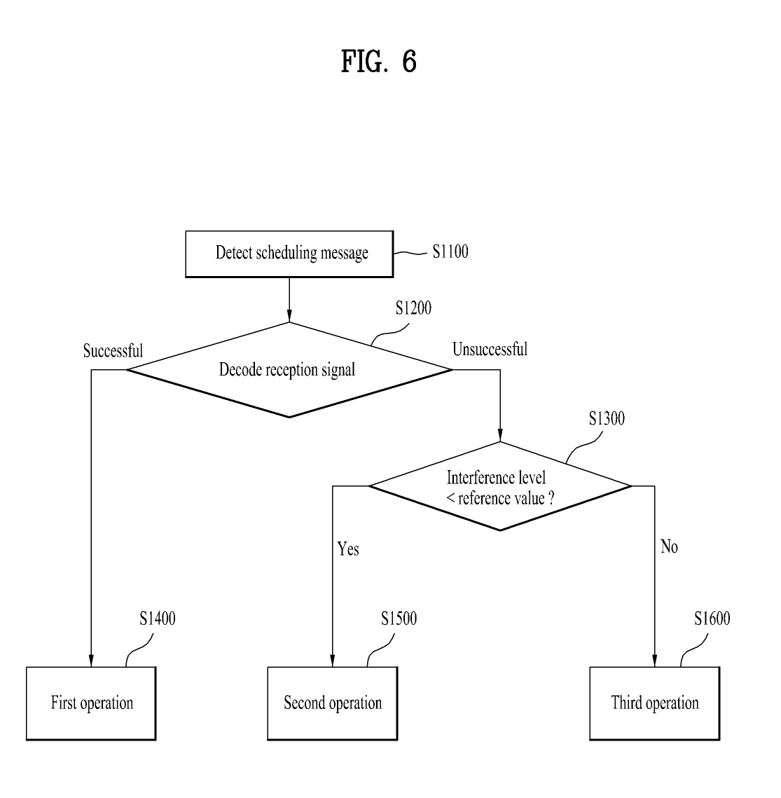

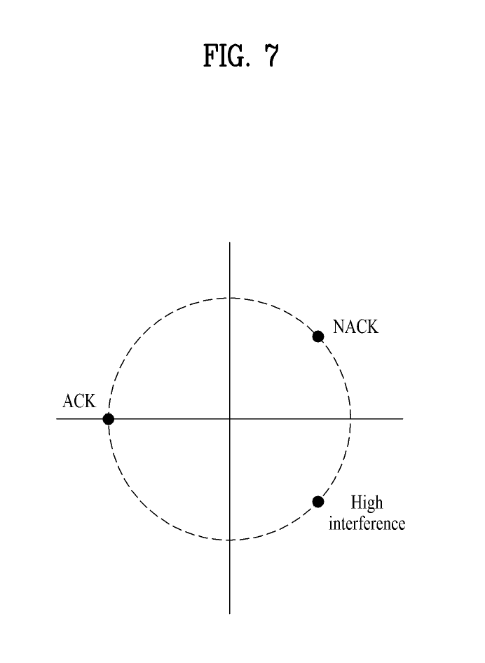

FIG. 6 illustrates a flow of a HARQ operation according to the present invention.

Referring to FIG. 6, a UE receives a scheduling message (i.e. DL grant) for a signal to be received (S1100). The scheduling message may be received through a PDCCH. It is assumed in the present invention that the scheduling message is transmitted to the UE through a more stable channel with a high success probability. In other words, it is assumed that the UE has been successfully detected the scheduling message. If communication is performed between UEs as in FIG. 5(a), the scheduling message may be transmitted by the eNB. If communication is performed in an unlicensed band as in FIG. 5(b), the scheduling message may be transmitted to the UE through a separate licensed band or may be received by the UE through the licensed band.

The UE, which has stably received the scheduling message, that is, the UE, which has successfully detected the scheduling message, decodes a reception signal according to the contents of the detected scheduling message (S1200). The UE may decode a signal received through a PDSCH according to the contents of the scheduling message. For example, the UE may decode a signal received on a time-frequency resource indicated by the scheduling message based on an MCS indicated by the scheduling message.

If the reception signal has been successfully decoded (S1200, successful), the UE performs a first operation (S1400). For instance, the first operation may be an operation in which the UE transmits HARQ-ACK set to ACK for the reception signal. Upon receiving ACK, a scheduling device which has transmitted the scheduling message or a transmitting device which has transmitted the (data) signal may be aware that the (data) signal has been successfully received by the UE. Then, the scheduling device or the transmitting device may transmit new data to the UE instead of transmitting a retransmission signal for the (data) signal to the UE.

Upon failing to decode the reception signal (S1200, unsuccessful), the UE performs a second operation (S1500) or a third operation (S1600) according to an interference level of the reception signal (S1300).

For example, decoding of the reception signal based on the scheduling message is not successful, the UE determines an interference level of the reception signal or checks whether a transmission signal by an adjacent device has collided with the reception signal. If interference experienced by the reception signal until the reception signal reaches the UE is less than a predetermined level (S1300, Yes), the UE may perform the second operation (S1500). For example, the second operation may be an operation in which the UE transmits HARQ-ACK set to NACK with respect to the reception signal. Upon receiving NACK, the transmitting device which has transmitted the scheduling message or the (data) signal to the UE may be aware that the (data) signal has not been successfully received by the UE. Then, the transmitting device may transmit a retransmission signal for restoring or recovering the (data) signal to the UE.

Meanwhile, if the UE fails to decode the signal received based on the scheduling message (S1200, unsuccessful) and determines that the reception signal has undergone severe interference prior to reception by the UE (or determines that a signal that should be received on a time-frequency resource indicated by the scheduling message has not been detected) (S1300, No), the UE may perform the third operation (S1600).

The UE may determine the interference level of the reception signal or collision between a transmission signal by another device and the reception signal by checking a level of quality when a signal transmitted by a transmitting device as a predetermined sequence such as a preamble or an RS included in the reception signal is received by the UE (hereinafter, reception signal quality). If the reception signal quality (e.g. signal to interference plus noise ratio (SINR), reference signal received quality (RSRQ), etc.) of the preamble or the RS is less than a predetermined level, the UE may determine that the interference level of the reception signal is serious or that the reception signal has collided with the transmission signal of another device. As another example, if the UE has not detected a signal transmitted as the predetermined sequence included in the reception signal (e.g. preamble, RS, etc.) or if a receive power of the corresponding signal (e.g. a reference signal received power (RSRP)) is less than the predetermined level, the UE may determine that the interference level of the reception signal is serious or that the reception signal has collided with the transmission signal of another device. The interference level of the reception signal can be discerned based on the quality of the reception signal. Hence, if the UE fails to decode the reception signal (S1200, unsuccessful), the UE may perform the second operation (S1500) or the third operation (S1600) according to the quality of the reception signal (S1300). For example, if the quality of the reception signal is above a predetermined level, the UE may perform the second operation and, if the quality of the reception signal is less than the predetermined level, the UE may perform the third operation.

The third operation may include an operation in which the UE discards the reception signal without storing the reception signal in a HARQ buffer. The third operation may include an operation in which the UE reports seriousness of the interference level, poor quality of the reception signal, detection failure of the reception signal, or discardment of the reception signal to a transmitting device which has transmitted the reception signal or an eNB which is in charge of scheduling. Such reporting may be performed as part of HARQ-ACK feedback indicating whether the reception signal has been successfully received. For example, a UE receiving one codeword may categorize HARQ-ACK feedback into three states of ACK, NACK, and reception signal discardment and report the state of the reception signal using the three states. Here, reception signal discardment may indicate seriousness of the interference level experienced by the reception signal, deterioration of quality of the reception signal, detection failure of the reception signal by the UE, and/or discardment of the reception signal by the UE.

FIG. 7 illustrates an exemplary HARQ-ACK feedback method according to the present invention.

When one of the three states indicating whether the reception signal has been successfully received is reported as HARQ-ACK feedback, NACK and reception signal discardment indicate failure of signal reception and are similar to each other in that signal retransmission is needed. Accordingly, in a HARQ feedback process, even if a state of NACK is misrecognized as a state of reception signal discardment or the state of reception signal discardment is misrecognized as the state of NACK, the influence of such an error on the HARQ process may be limited relative to the influence of an error misrecognizing NACK or reception signal discardment as ACK on the HARQ process. Therefore, referring to FIG. 7, to aid in improving performance of HARQ-ACK feedback, the states of HARQ-ACK feedback may be modulated such that the distance between the NACK state and the reception signal discardment state is reduced on a signal constellation, whereas the distance between the NACK state and the ACK state and the distance between the reception signal discardment state and the ACK state are increased on the signal constellation. When performing the first, second, and third operations of FIG. 6, the UE of the present invention may indicate ACK, NACK or reception signal discardment by modulating a HARQ-ACK signal to states as illustrated in FIG. 7. A scheduling device (i.e. scheduler) which has received HARQ-ACK indicating reception signal discardment may perform a retransmission operation under the assumption that the reception signal has not been stored in a HARQ buffer of a receiving device. For example, the transmitting device which has received ACK may transmit new data, a redundancy version of which is set to 0, the transmitting device which has received NACK may transmit retransmission data, a redundancy version of which is set to ‘redundancy version of previously transmitted data+1’, and the transmitting device which has received reception signal discardment may retransmit a signal, a redundancy version of which is the same as a redundancy version of a discarded reception signal. Meanwhile, since a signal previously transmitted by the transmitting device has not been stored in the HARQ buffer of the receiving device, the retransmission operation may be performed using large resources compared with resources used when the previously transmitted signal is stored in the HARQ buffer of the receiving device.

As another example of the third operation performed when the interference level of the reception signal is serious or the UE fails to detect the reception signal, the UE which has determined to discard the reception signal may report that the interference level of the reception signal is serious or the reception signal has been not detected to the transmitting device of the reception signal or the scheduler by not transmitting an ACK/NACK signal for the reception signal. In this case, a device which is in charge of scheduling may perform the retransmission operation for the previously transmitted signal under the assumption that the UE has not received or detected the scheduling message for the reception signal. If the UE has not received or detected the scheduling message, since the UE is not aware of the presence of a corresponding (data) signal according to the scheduling message, the UE is incapable of receiving or detecting the (data) signal transmitted by the transmitting device, decoding the (data) signal, and storing the (data) signal in the HARQ buffer. Accordingly, the scheduling device or transmitting device for generating or transmitting the scheduling message may perform the retransmission operation under the assumption that the UE has not stored the (data) signal associated with the scheduling message in the HARQ buffer of the UE.

As a further example of the third operation performed when the interference level of the reception signal is serious or the UE has failed to detect the reception signal, the UE may indicate whether the reception signal is discarded by additionally using a feedback channel designated by a higher layer signal such as a radio resource control (RRC) signal and also report HARQ-ACK. For example, if the UE performs reception signal discardment, the UE may transmit a signal of a constant power through the predesignated feedback channel and, if not, the UE may transmit no signal through the predesignated feedback channel and report HARQ-ACK using an existing feedback channel. In the case of reporting reception signal discardment through the additional feedback channel, the UE may report the reason for discarding the reception signal (e.g. the reason why the reception signal is discarded is because a preamble or an RS has not been detected or because the preamble or RS has been detected but quality of the detected signal is less than a predetermined level), the magnitude of an interference signal (e.g. relative magnitude of interference to the reception signal) when there is interference, or quality of the reception signal (e.g. RSRP, RSRQ, or SINR of the reception signal), using the additional feedback channel, so that the scheduler may refer to the reason why the signal previously transmitted to the UE is discarded by the UE when performing scheduling related to retransmission.

When the UE reports a signal for which HARQ-ACK is to be transmitted to the transmitting device or scheduler by feeding back a modulation symbol indicating reception signal discardment, dropping transmission of an ACK/NACK feedback signal, or reporting reception signal discardment through the additional feedback channel, the transmitting device or the scheduler may determine that the signal has been missed and perform retransmission to the UE as if the signal had not been transmitted. For example, if a redundancy version of a target signal of HARQ-ACK is “x”, the transmitting device or the scheduler may transmit a scheduling message, a redundancy version of which is also set to “x”, to the UE. Nonetheless, the scheduling message may indicate a different radio frequency resource and/or MCS from those of previous transmission of the target signal. That is, the signal retransmitted to the UE carries the same information as information of previous transmission but may be modulated and coded according to a different MCS and/or may be transmitted through a different radio frequency resource.

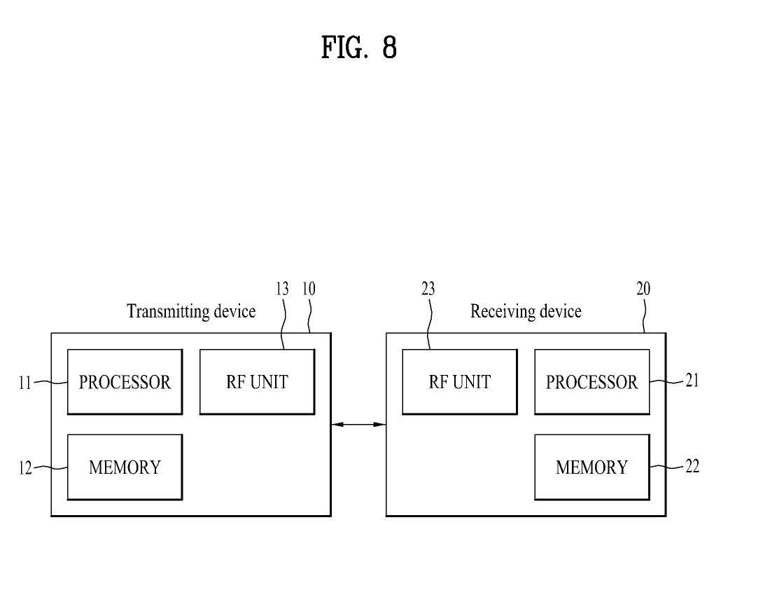

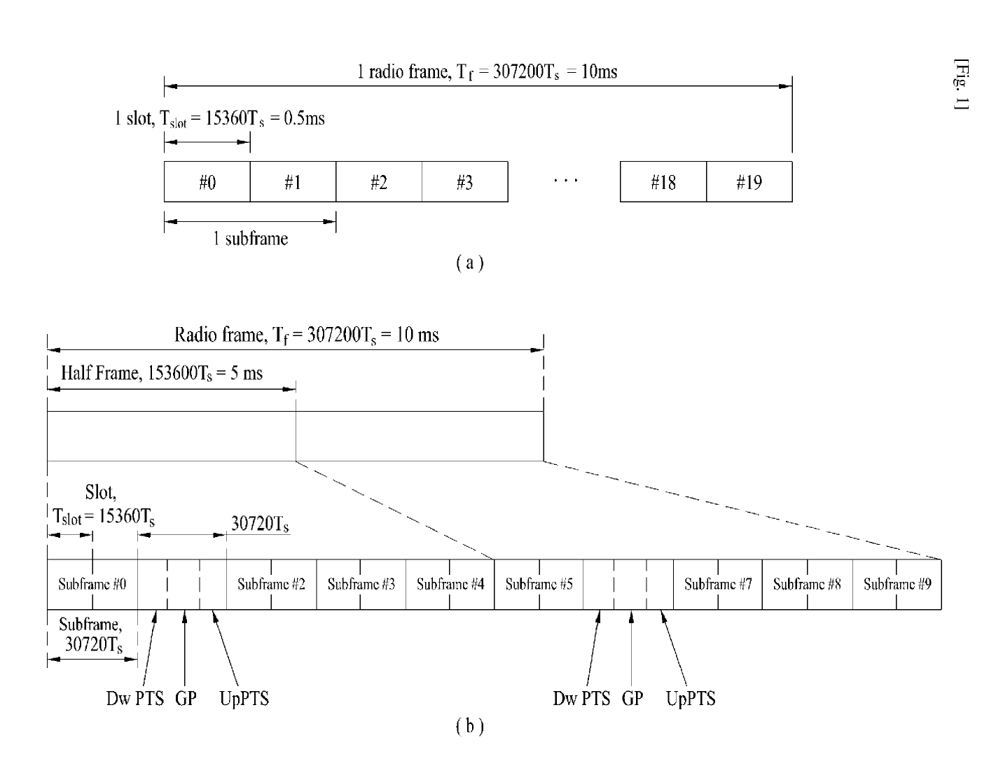

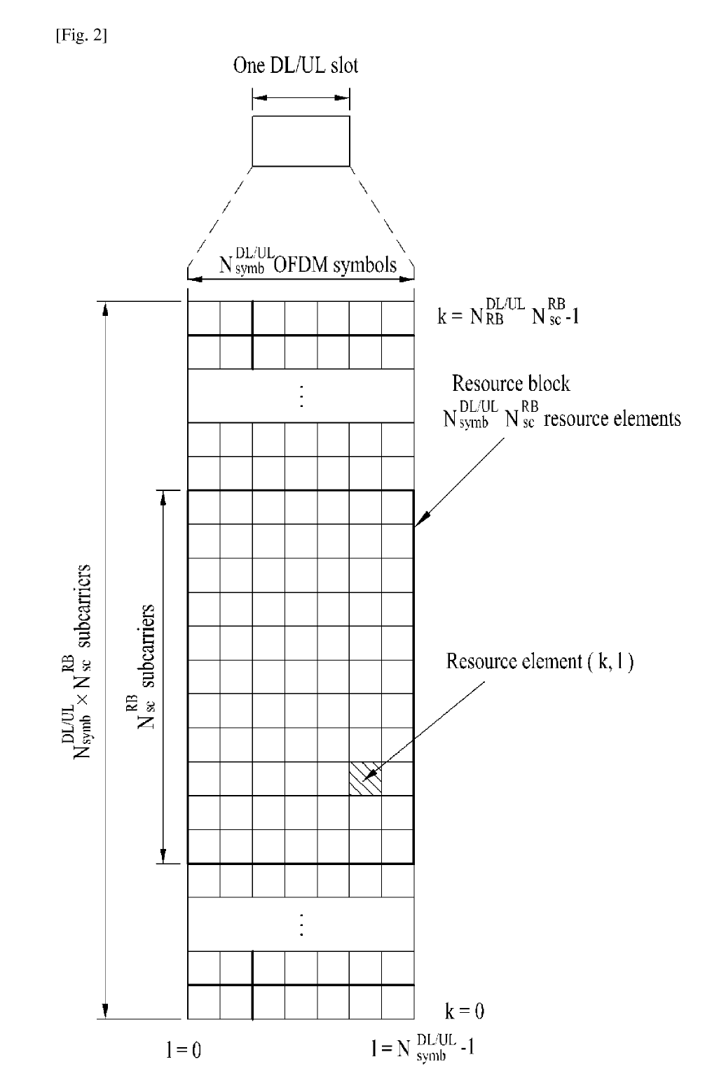

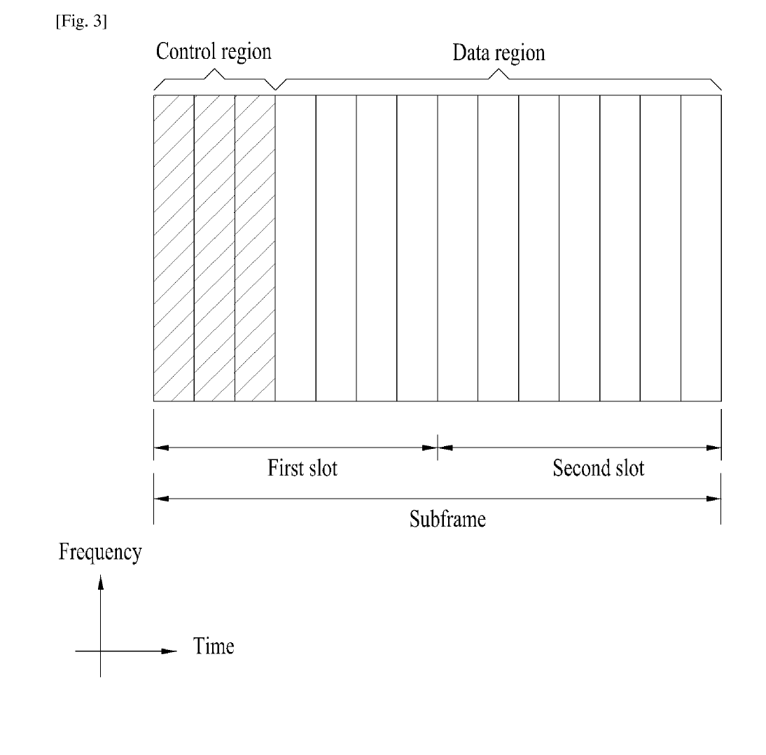

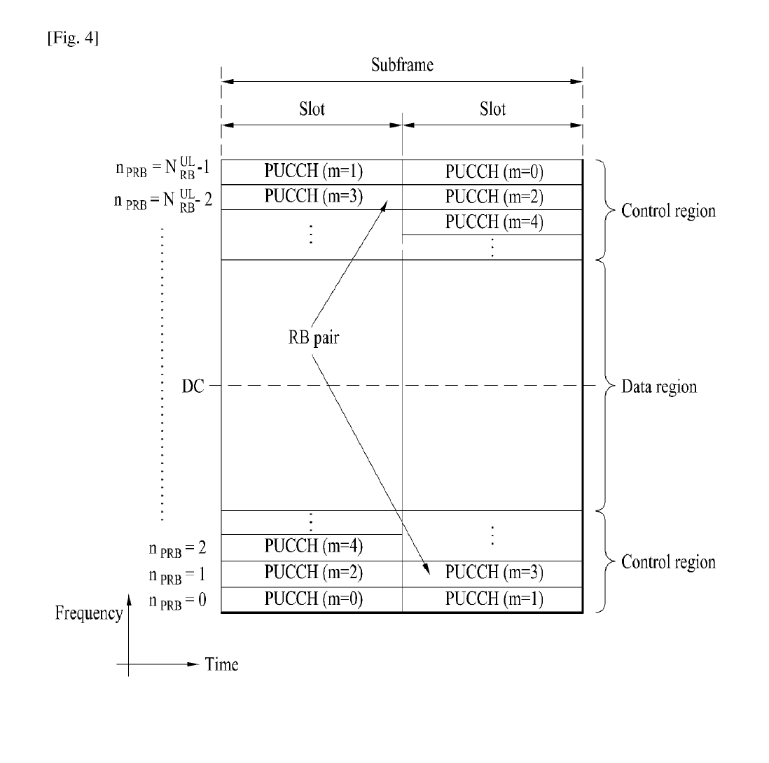

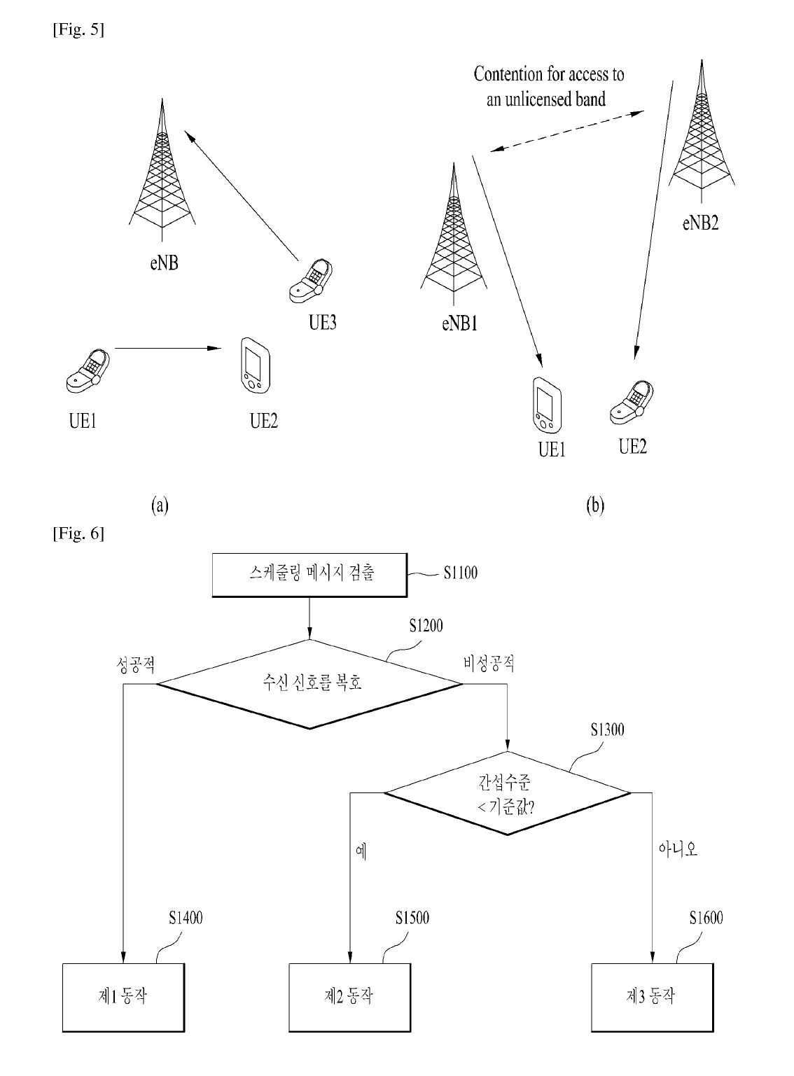

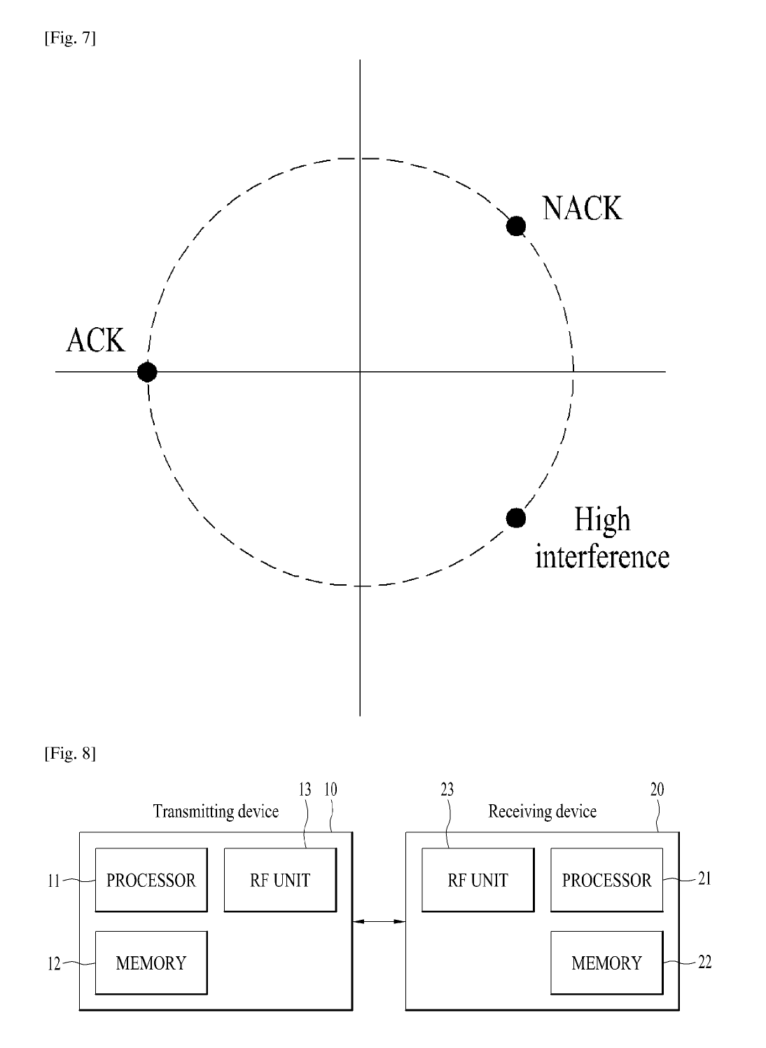

FIG. 8 is a block diagram illustrating elements of a transmitting device 10 and a receiving device 20 for implementing the present invention.

The transmitting device 10 and the receiving device 20 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 performs predetermined coding and modulation for a signal and/or data scheduled to be transmitted to the outside by the processor 11 or a scheduler connected with the processor 11, and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer) transmit antennas.

A signal processing process of the receiving device 20 is the reverse of the signal processing process of the transmitting device 10. Under control of the processor 21, the RF unit 23 of the receiving device 20 receives radio signals transmitted by the transmitting device 10. The RF unit 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 10 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 20. An RS transmitted through a corresponding antenna defines an antenna from the view point of the receiving device 20 and enables the receiving device 20 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An RF unit supporting a MIMO function of transmitting and receiving data using a plurality of antennas may be connected to two or more antennas.

In the embodiments of the present invention, referring to FIG. 5(a), in UE-to-UE communication, one UE operates as the transmitting device 10 and another UE operates as the receiving device 20. In UE-to-UE communication, scheduling information for a data signal transmitted from one UE to another UE may be transmitted to one UE and another UE by an eNB. In the embodiments of the present invention, referring to FIG. 5(b), a UE operates as the transmitting device 10 in UL and as the receiving device 20 in DL and an eNB operates as the receiving device 20 in UL and as the transmitting device 10 in DL. In the embodiments of the present invention, an eNB may include a scheduler and the scheduler may generate scheduling information for a data signal to be received by a UE and provide the scheduling information to a UE. Hereinafter, the embodiments of the present invention will be described again by referring to the processor, RF unit, and memory included in the UE as a UE processor, a UE RF unit, and a UE memory, respectively, and referring to the processor, RF unit, and memory unit included in the eNB as an eNB processor, an eNB RF unit, and an eNB memory, respectively, under the assumption that the eNB includes a scheduler, for convenience of description.

Referring to FIG. 6, the UE processor may control the UE RF unit to receive a scheduling message (i.e. DL grant) for a signal to be received (hereinafter, data signal). Upon detecting the scheduling message (S1100), the UE processor may decode a signal received by the UE RF unit on a radio time-frequency resource indicated by the scheduling message according to the contents of the scheduling message (S1200). The scheduling message may be transmitted to the UE by the eNB. The data signal according to the scheduling message may be transmitted the UE by the eNB or another UE.

Upon successfully decoding the data signal (S1200, successful), the UE processor may perform the first operation (S1400). For example, the UE processor may control the UE RF unit to transmit HARQ-ACK set to ACK for the data signal to the eNB or to a transmitting device of the data signal. Upon receiving ACK, the transmitting device which has transmitted the scheduling message or the data signal to the UE may be aware that the data signal has been successfully received by the UE. Then, the eNB or the other UE which has transmitted the data signal may transmit new data to the UE instead of transmitting a retransmission signal for restoring or recovering the data signal to the UE. In this case, the eNB processor may include, in a newly transmitted scheduling message, information indicating that a target data of the scheduling message is new data.

Upon failing to decode the data signal (S1200, unsuccessful), the UE processor may control the UE memory and the UE RF unit to perform a second operation (S1500) or a third operation (S1600) according to an interference level of the data signal (S1300).

For example, decoding of the data signal received based on the scheduling message is not successful, the UE processor may be configured to determine an interference level of the data signal or check whether a transmission signal by an adjacent device has collided with the data signal. If interference undergone by the data signal until the data signal reaches the UE is less than a predetermined level (S1300, Yes), the UE processor may perform the second operation (S1500). For example, for the second operation, the UE processor may be configured to set HARQ-ACK for the data signal to NACK and may control the UE RF unit to transmit HARQ-ACK to the transmitting device which has transmitted the scheduling message or the data signal. Upon receiving NACK, an RF unit of the transmitting device which has transmitted the scheduling message or the data signal to the UE may be aware that the data signal has not successfully received by the UE. Then, the RF unit of the transmitting device may transmit a retransmission signal for restoring or recovering the data signal to the UE according to control of a processor of the transmitting device or control of the eNB processor for scheduling transmission by the transmitting device.

Meanwhile, if the UE processor fails to decode the data signal received based on the scheduling message (S1200, unsuccessful) and determines that the data signal has undergone severe interference prior to reception by the UE (or determines that a signal that should be received on a time-frequency resource indicated by the scheduling message has not been detected) (S1300, No), the UE processor may control the UE memory and the UE RF unit to perform the third operation (S1600).

The UE processor may determine the interference level of the data signal or collision between a transmission signal by another device and the data signal by checking a level of quality when a signal transmitted by a transmitting device is received by the UE (hereinafter, reception signal quality) using a predetermined sequence such as a preamble or an RS included in the data signal. If the reception signal quality (e.g. SINR, RSRQ, etc.) of the preamble or the RS is less than a predetermined level, the UE processor may determine that the interference level of the data signal is serious or that the data signal has collided with the transmission signal of another device. As another example, if the UE processor has not detected a signal transmitted as the predetermined sequence included in the data signal (e.g. the preamble, RS, etc.) or if a receive power of the sequence signal (e.g. RSRP) is less than a predetermined level, the UE may determine that the interference level of the data signal is serious or that the data signal has collided with the transmission signal of another device. The interference level of the data signal can be discerned based on the quality of the data signal. Hence, if the UE processor fails to decode the data signal (S1200, unsuccessful), the UE processor may control the UE RF unit and the UE memory to perform the second operation (S1500) or the third operation (S1600) according to the quality of the data signal (S1300). For example, if the receive quality of the data signal is above a predetermined level, the UE processor may control the UE RF unit and the UE memory to perform the second operation and, if the quality of the data signal is less than the predetermined level, the UE processor may control the UE RF unit and the UE memory to perform the third operation. The UE processor may perform the third operation by discarding the data signal without storing the data signal in a HARQ buffer of the UE memory. The UE processor may perform the third operation by controlling the UE RF unit to report seriousness of the interference level, poor quality of the reception signal, detection failure of the data signal, or discardment of the reception signal to a transmitting device which has transmitted the data signal or an eNB which has transmitted the scheduling message. According to an embodiment of the present invention, the reception states of the data signal may be categorized into three states of ACK, NACK, and reception signal discardment, for HARQ-ACK feedback. On a signal constellation, the distance between the NACK state and the reception signal discardment state may be nearer than the distance between the NACK state and the ACK state and the distance between the reception signal discardment state and the ACK state. The eNB processor which has received HARQ-ACK indicating reception signal discardment may control another UE (in the case of UE-to-UE communication) or the eNB RF unit (in the case of eNB-to-UE communication) to perform a retransmission operation under the assumption that the data signal has not been stored in a HARQ buffer of a receiving UE. For example, the eNB processor which has received ACK may control another UE or the eNB RF unit to transmit new data, a redundancy version of which is set to 0. The eNB processor which has received NACK may control another UE or the eNB RF unit to transmit retransmission data, a redundancy version of which is set to ‘redundancy version of previously transmitted data+1’. The eNB processor which has received reception signal discardment may control another UE or the eNB RF unit to retransmit a data signal, a redundancy version of which is the same as a redundancy version of a discarded data signal. In addition, the eNB processor may control the RF unit of the transmitting device to retransmit a data signal using large resources compared with resources used when the transmitting device (another UE or eNB) which has transmitted the previous data signal transmits the previous data signal.

Meanwhile, the UE processor may report that the interference level of the data signal is serious or the data signal has been not detected to a transmitting device which has transmitted the data signal or a transmitting device which has transmitted the scheduling message for the data signal by not transmitting an ACK/NACK signal. In this case, a device which is in charge of scheduling, for example, the eNB processor may perform the retransmission operation for the previously transmitted signal under the assumption that the UE has not received or detected the scheduling message for the data signal.

When the interference level of the data signal is serious or the UE processor has failed to detect the data signal, the UE processor may indicate whether the reception signal is discarded by additionally using a feedback channel designated by a higher layer signal such as an RRC signal and also report HARQ-ACK. For example, if the UE processor performs reception signal discardment, the UE processor may control the UE RF unit to transmit a signal of a constant power through the predesignated feedback channel and, if not, the UE processor may control the UR RF unit to transmit no signal through the predesignated feedback channel and to report HARQ-ACK using an existing feedback channel. In the case of reporting reception signal discardment through an additional feedback channel, the UE processor may control the UE RF unit to report the reason for discarding the reception signal, the magnitude of an interference signal, or quality of the reception signal, the UE processor may inform the scheduler (e.g. eNB processor) of the reason why the data signal is discarded by the UE.

According to the present invention, a signal which is subject to severe interference can be prevented from being combined with another signal. In addition, according to the present invention, signal retransmission can be performed in consideration of a signal which is not combined with another signal. Accordingly, according to the present invention, a HARQ process can be more efficiently performed.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable to a base station, a UE, or other devices in a wireless communication system.

1. A method for receiving a signal by a user equipment, the method comprising:
decoding a data signal based on a scheduling message for the data signal; and
transmitting acknowledgement (ACK)/negative acknowledgement (HACK) feedback including an ACK/NACK response to the data signal,
wherein if the data signal is successfully decoded, the ACK/NACK response is set to a first value indicating successful reception, if the data signal is unsuccessfully decoded and reception quality of the data signal is greater than a reference value, the ACK/NACK response is set to a second value indicating unsuccessful reception, and if the data signal is unsuccessfully decoded and reception quality of the data signal is less than the reference value, the ACK/NACK response is set to a third value indicating detection failure of the data signal or the ACK/NACK response is dropped.

2. The method according to claim 1, further comprising
discarding the data signal from a hybrid automatic retransmission request (HARQ) buffer of the user equipment if the data signal is unsuccessfully decoded and reception quality of the data signal is less than the reference value.

3. The method according to claim 1, wherein the data signal is decoded when the scheduling message is successfully decoded.

4. The method according to claim 1, further comprising:
receiving another data signal having the same redundancy version as a redundancy version of the data signal if the data signal is unsuccessfully decoded and reception quality of the data signal is less than the reference value.

5. A user equipment for receiving a signal, the user equipment comprising:
a radio frequency (RF) unit; and
a processor configured to control the RF unit,
wherein the processor controls the RF unit to receive a scheduling message for a data signal, decodes the data signal based on the scheduling message, and controls the RF unit to transmit acknowledgement (ACK)/negative acknowledgement (NACK) feedback including an ACK/NACK response to the data signal, and
wherein if the data signal is successfully decoded, the processor sets the ACK/NACK response to a first value indicating successful reception, if the data signal is unsuccessfully decoded and reception quality of the data signal is greater than a reference value, the processor sets the ACK/NACK response to a second value indicating unsuccessful reception, and if the data signal is unsuccessfully decoded and reception quality of the data signal is less than the reference value, the processor sets the ACK/NACK response to a third value indicating detection failure of the data signal or drops the ACK/NACK response.

6. The user equipment according to claim 5, wherein the processor discards the data signal from a hybrid automatic retransmission request (HARQ) buffer of the user equipment if the data signal is unsuccessfully decoded and reception quality of the data signal is less than the reference value.

7. The user equipment according to claim 5, wherein the processor decodes the data signal when the scheduling message is successfully decoded.

8. The user equipment according to claim 5, wherein the RF unit receives another data signal having the same redundancy version as a redundancy version of the data signal if the data signal is unsuccessfully decoded and reception quality of the data signal is less than the reference value.

9. A method for transmitting a signal by a transmitting device, the method comprising:
transmitting a data signal based on a scheduling message for the data signal to a user equipment; and
receiving acknowledgement (ACK)/negative acknowledgement (NACK) feedback from the user equipment,
wherein if an ACK/NACK response of the ACK/NACK feedback to the data signal is set to a first value, the transmitting device assumes that the data signal has been successfully received by the user equipment, if the ACK/NACK response of the ACK/NACK feedback is set to a second value, the transmitting device assumes that the data signal has been unsuccessfully received by the user equipment, and if the ACK/NACK response of the ACK/NACK feedback indicates detection failure of the data signal or if the ACK/NACK feedback does not include the ACK/NACK response, the transmitting device assumes that the data signal has been received by the user equipment with quality less than a reference value.

10. A transmitting device for transmitting a signal, the transmitting device comprising:
a radio frequency (RF) unit; and
a processor configured to control the RF unit,
wherein the processor controls the RF unit to transmit a data signal based on a scheduling message for the data signal to a user equipment, and controls the RF unit to receive acknowledgement (ACK)/negative acknowledgement (NACK) feedback including an ACK/NACK response to the data signal from the user equipment, and
wherein if the ACK/NACK response of the ACK/NACK feedback to the data signal is set to a first value, the processor assumes that the data signal has been successfully received by the user equipment, if the ACK/NACK response of the ACK/NACK feedback is set to a second value, the processor assumes that the data signal has been unsuccessfully received by the user equipment, and if the ACK/NACK response of the ACK/NACK feedback indicates detection failure of the data signal or if the ACK/NACK feedback does not include the ACK/NACK response, the processor assumes that the data signal has been received by the user equipment with quality less than a reference value.
